(19) United States
(12) Patent Application Publication
(10) Pub. No.: US 2024/0403604 A1
(43) Pub. Date: Dec. 5, 2024

(54) Automatic Tokenization of Features Using Machine Learning

(71) Applicant: Bank of America Corporation, Charlotte, NC (US)

(72) Inventors: Shola Oni, Atlanta, GA (US); Vijaya L. Vemireddy, Charlotte, NC (US); Diana Nicholson, Charlotte, NC (US); Jennifer Renckert, Middleburg, FL (US)

(21) Appl. No.: 18/203,210

(22) Filed: May 30, 2023

(51) Int. Cl. G06N 3/045; G06Q 30/0601

(52) U.S. Cl. CPC G06N 3/045; G06Q 30/0631

(57) ABSTRACT

Aspects of the disclosure relate to generating recommendations for a user based on the customer's account information and the customer's activity on one or more media platforms using multiple machine learning (ML) models. A computing platform may determine a plurality of account features based on the account information via a user ML model. The computing platform may determine a plurality of media features based on unstructured media data via a media ML model. A recommendation ML model generates tokens representing each of the plurality of account features and each of the plurality of media features in a fully connected graph structure. The recommendation ML model processes and outputs a recommendation score based on the tokens in the fully connected graph structure. A recommendation is generated by the computing platform based on the recommendation score.

### BACKGROUND

Enterprise organizations have various computer infrastructure to assist in servicing their customers or clients. Customers of an enterprise organization may include small businesses. Small business owners may be unfamiliar with planning an appropriate budget, monitoring spending and costs to stay on budget, or knowing the full line of services an enterprise organization offers. In some instances, it may be difficult for an enterprise organization to identify the needs of a specific customer.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of this disclosure provide effective, efficient, scalable, and convenient technical solutions that address various issues in the prior art with generating recommendations based on a user's account information and the user's activity on one or more media platforms using multiple machine learning (ML) models.

In accordance with one or more embodiments, a computing platform having at least one processor, and memory, may receive account information associated with a user account. The account information associated with the user account comprises historical account data and one or more user-defined account rules. The account information is input into a user machine learning (ML) model. The user ML model processes the historical account data and the one or more user-defined account rules to determine a plurality of account features. The user ML model outputs the plurality of account features. Then, the computing platform receives unstructured media data from a media platform. The unstructured media data is input into a media ML model. The media ML model processes the unstructured media data to determine a plurality of media features. The media ML model outputs the plurality of media features. Next, the plurality of account features and the plurality of media features are input into a recommendation ML model. The recommendation ML model generates tokens representing each of the plurality of media features and each of the plurality of account features. The tokens are connected together in a fully connected graph structure. Each of the tokens representing media features not matching with any of the tokens representing the plurality of account features are deleted from the fully connected graph structure. A recommendation score is processed based on the tokens in in the fully connected graph structure representing the plurality of account features and the plurality of media features. Subsequently, the computing platform generates a recommendation for the user account based on the recommendation score and sends the recommendation to a user computing device associated with the user account.

In some embodiments, the recommendation is sent to the user computing device in a text message, e-mail message, or a push notification message.

In some embodiments, the media platform comprises at least one of a social media platform or an online marketplace, or a combination thereof.

In some embodiments, the computing platform retrieves from one or more external sources of data, one or more events that may impact the recommendation and location information associated with the user account. The recommendation is then modified for the user account based on the one or more events that may impact the recommendation and the location information.

In some embodiments, the one or more events comprise at least one of a weather-related event, an employment related event, a geopolitical event, or a civic unrest event, or a combination thereof.

In some embodiments, the unstructured media data comprises at least one of textual data, image data, audio data, or video data, or a combination thereof.

In some embodiments, the user ML model is trained based on the historical account data and one or more user-defined account rules to determine the plurality of account features.

In some embodiments, the media ML model is trained based on a plurality of unstructured media data to determine the plurality of media features.

In some embodiments, the recommendation ML model is trained based on the plurality of account features and the plurality of media features to determine the recommendation score.

In some embodiments, the one or more user-defined account rules comprise at least one or more rules associated with an automatic loan amount, a secondary funding source, automatic payment options, a budget for a specific period of time, a designated alternate decision making authority, or preferred communication channels, or a combination thereof.

In some embodiments, the recommendation comprises at least one of an action for the user account to open a small business account, open a checking account, open a savings account, apply for a credit card, or open a line of credit, or a combination thereof.

In some embodiments, the recommendation comprises at least one of an action for the user account to decrease spending on a transaction, increase spending on a transaction, or modify a budget for a specific period of time, or a combination thereof.

These and additional aspects will be appreciated with the benefit of the disclosures discussed in further detail below. Moreover, the figures herein illustrate the foregoing embodiments in detail.

### BRIEF DESCRIPTION OF THE DRAWINGS

A more complete understanding of aspects described herein and the advantages thereof may be acquired by referring to the following description in consideration of the accompanying drawings, in which like reference numbers indicate like features.

FIG. 1 depicts an illustrative example of a computer system in accordance with one or more illustrative aspects described herein.

FIG. 2 depicts an illustrative example of a recommendation computing platform in accordance with one or more examples described herein.

FIG. 3 depicts an illustrative artificial neural network on which one or more machine learning algorithms may be executed in accordance with one or more examples described herein.

FIG. 4 depicts an illustrative example of a suitable computing system environment that may be used in accordance with one or more illustrative aspects described herein.

FIG. 5A depicts an illustrative event sequence in accordance with one or more illustrative aspects described herein.

FIG. 5B depicts an illustrative event sequence in accordance with one or more illustrative aspects described herein.

FIG. 6 shows an illustrative flowchart in accordance one or more illustrative aspects described herein.

### DETAILED DESCRIPTION

In the following description of the various embodiments, reference is made to the accompanying drawings identified above and which form a part hereof, and in which is shown by way of illustration various embodiments in which aspects described herein may be practiced. It is to be understood that other embodiments may be utilized and structural and functional modifications may be made without departing from the scope described herein. Various aspects are capable of other embodiments and of being practiced or being carried out in various different ways. It is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof.

It is noted that various connections between elements are discussed in the following description. It is noted that these connections are general and, unless specified otherwise, may be direct or indirect, wired or wireless, and that the specification is not intended to be limiting in this respect.

As a general introduction to the subject matter described in more detail below, aspects described herein are directed towards the methods and systems disclosed herein. Aspects of this disclosure provide effective, efficient, scalable, and convenient technical solutions that address various issues in the prior art with generating recommendations for users based on the users's account information and the user's activity on one or more media platforms using multiple machine learning (ML) models.

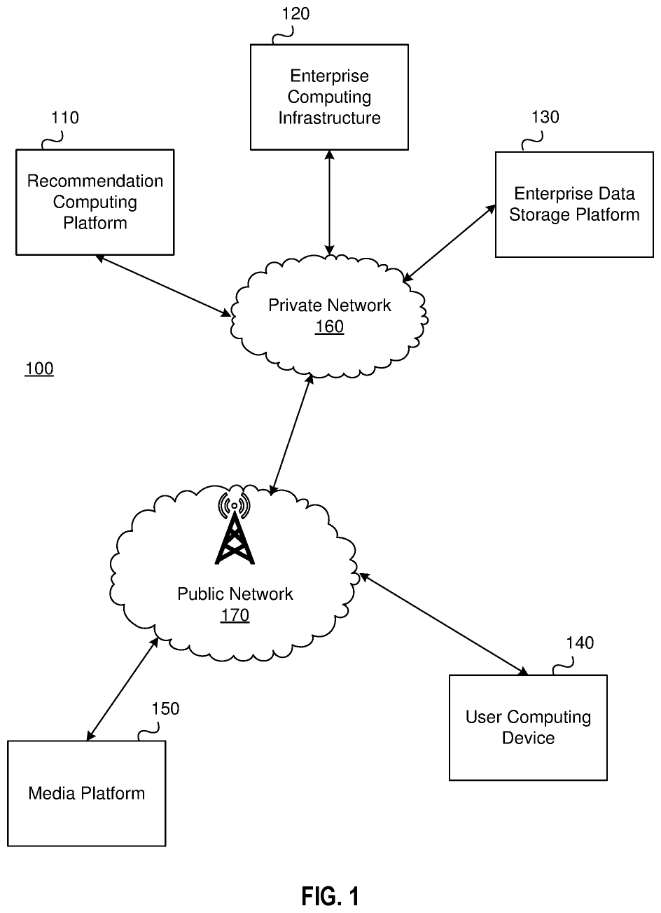

FIG. 1 depicts an illustrative example of computer environment 100 in accordance with one or more illustrative aspects described herein. Computer environment 100 may comprise one or more computing devices and/or computer systems. For example, computing environment 100 may include a recommendation computing platform 110, an enterprise computing infrastructure 120, an enterprise data storage platform 130, a user computing device 140, and a media platform 150. In some arrangements, computer environment 100 may include additional computing devices, computing systems, computing platforms, and networks that are not depicted in FIG. 1.

As illustrated in greater detail below, recommendation computing platform 110 may include one or more computing devices configured to perform one or more of the functions described herein. For example, recommendation computing platform 110 may include one or more computers (e.g., laptop computers, desktop computers, servers, server blades, or the like) and/or other computer components (e.g., processors, memories, communication interfaces).

Enterprise computing infrastructure 120 may be associated with a distinct entity such as a company, enterprise organization and the like, and may comprise one or more personal computer(s), server computer(s), hand-held or laptop device(s), multiprocessor system(s), microprocessor-based system(s), set top box(es), programmable consumer electronic device(s), network personal computer(s) (PC), minicomputer(s), mainframe computer(s), distributed computing environment(s), and the like. Enterprise computing infrastructure 120 may include computing hardware and software that may be configured to host, execute, and/or otherwise provide various data or one or more enterprise applications. For example, enterprise computing infrastructure 120 may be configured to host, execute, and/or otherwise provide one or more media platforms to provide unstructured media data (textual data, image data, video data, audio data and the like), transaction processing programs, an enterprise mobile application for user devices, automated payment functions, loan processing programs, and/or other programs associated with an enterprise server. In some instances, enterprise computing infrastructure 120 may be configured to provide various enterprise and/or back-office computing functions for an enterprise organization, such as a financial institution. For example, enterprise computing infrastructure 120 may include various servers and/or databases that store and/or otherwise maintain account information, such as financial account information including account balances, historical account data, one or more user-defined account rules, account owner information, and/or other information. In addition, enterprise computing infrastructure 120 may process and/or otherwise execute tasks on specific accounts based on commands and/or other information received from other computer systems included in computing environment 100. Additionally, or alternatively, enterprise computing infrastructure 120 may receive instructions from recommendation computing platform 110 and execute the instructions in a timely manner.

Enterprise data storage platform 130 may include one or more computing devices and/or other computer components (e.g., processors, memories, communication interfaces). In addition, and as illustrated in greater detail below, enterprise data storage platform 130 may be configured to store and/or otherwise maintain enterprise data. For example, enterprise data storage platform 130 may be configured to store and/or otherwise maintain, for enterprise customers (i.e., small businesses and the like), account information, payment information, payment schedules, patterns of activity, product and service offerings, discounts, and so forth. Additionally, or alternatively, enterprise computing infrastructure 120 may load data from enterprise data storage platform 130, manipulate and/or otherwise process such data, and return modified data and/or other data to enterprise data storage platform 130 and/or to other computer systems included in computing environment 100.

User computing device 140 may be a personal computing device (e.g., desktop computer, laptop computer) or mobile computing device (e.g., smartphone, tablet, wearable device). In addition, user device 140 may be linked to and/or used by a specific user (who may, e.g., be a customer of a financial institution or other organization operating recommendation computing platform 110). Also, for example, user of user device 140 may use user device 140 to perform transactions (e.g., perform banking operations, perform financial transactions, trade financial assets, and so forth), social media activities, and business activities (e.g., sell products and services, advertise products and services, etc.).

Media platform 150 may include one or more computers (e.g., laptop computers, desktop computers, servers, server blades, or the like) and/or other computer components (e.g., processors, memories, communication interfaces). Media platform 150 may generally be a social media platform and/or an online marketplace to provide products and services for sale, advertise products and services, generate social media posts related to products and services offered by a small business, and so forth. Although not illustrated herein, in some embodiments, media platform 150 may be a component of recommendation computing platform 110, or may be a standalone component connected to private network 160. Also, for example, media platform 150 may represent a plurality of media platforms.

Computing environment 100 also may include one or more networks, which may interconnect one or more of recommendation computing platform 110, enterprise computing infrastructure 120, enterprise data storage platform 130, user device 140, and media platform 150. For example, computing environment 100 may include a private network 160 (which may, e.g., interconnect recommendation computing platform 110, enterprise computing infrastructure 120, enterprise data storage platform 130, and/or one or more other systems which may be associated with an organization, such as a financial institution) and public network 170 (which may, e.g., interconnect user device 140 and media platform 150 with private network 160 and/or one or more other systems, public networks, sub-networks, and/or the like). Public network 170 may be a high generation cellular network, such as, for example, a 5G or higher cellular network. In some embodiments, private network 160 may likewise be a high generation cellular enterprise network, such as, for example, a 5G or higher cellular network. In other embodiments, one or more networks may also be a global area network (GAN), such as the Internet, a wide area network (WAN), a local area network (LAN), or any other type of network or combination of networks.

In one or more arrangements, recommendation computing platform 110, enterprise computing infrastructure 120, enterprise data storage platform 130, user device 140, media platform 150, and/or the other systems included in computing environment 100 may be any type of computing device capable of receiving input via a user interface, and communicating the received input to one or more other computing devices. For example, recommendation computing platform 110, enterprise computing infrastructure 120, enterprise data storage platform 130, user device 140, and media platform 150, and/or the other systems included in computing environment 100 may, in some instances, be and/or include server computers, desktop computers, laptop computers, tablet computers, smart phones, or the like that may include one or more processors, memories, communication interfaces, storage devices, and/or other components. As noted above, and as illustrated in greater detail below, any and/or all of recommendation computing platform 110, enterprise computing infrastructure 120, enterprise data storage platform 130, user device 140, and media platform 150, may, in some instances, be special-purpose computing devices configured to perform specific functions.

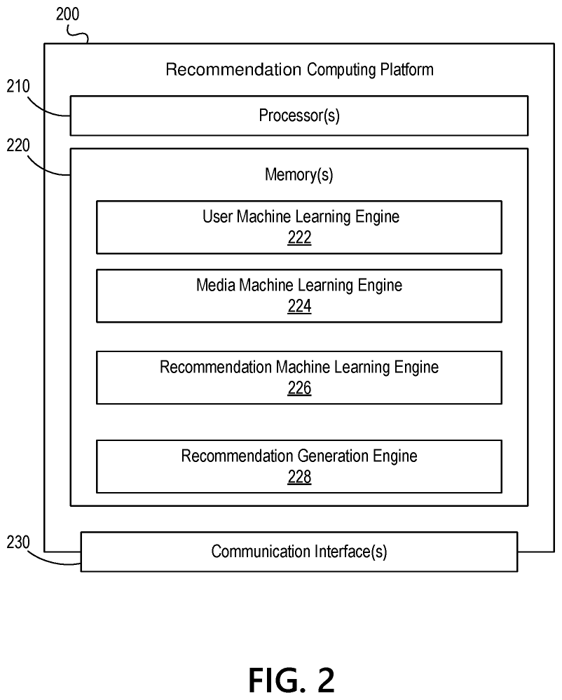

FIG. 2 depicts an illustrative example of a recommendation computing platform 200 in accordance with one or more examples described herein. Recommendation computing platform 200 may include one or more processors 210, memory 220, and communication interface 230. A data bus may interconnect processor 210, memory 220, and communication interface 230. Communication interface 230 may be a network interface configured to support communication between recommendation computing platform 200 and one or more networks (e.g., a public network, a private network, a local network, or the like). Memory 220 may include one or more program modules having instructions that when executed by processor 210 cause recommendation computing platform 200 to perform one or more functions described herein and/or one or more databases that may store and/or otherwise maintain information which may be used by such program modules and/or processor 210. In some instances, the one or more program modules and/or databases may be stored by and/or maintained in different memory units of recommendation computing platform 200 and/or by different computing devices that may form and/or otherwise make up recommendation computing platform 200. For example, memory 220 may have, store, and/or include a user machine learning engine 222, a media machine learning engine 224, a recommendation machine learning engine 226, and a recommendation generation engine 228.

User machine learning engine 222 may have instructions that direct and/or cause recommendation computing platform 200 to determine, via a user machine learning (ML) model and based on account information comprising historical account data and one or more user-defined account rules associated with a user account, a plurality of account features, as discussed in greater detail below. Media machine learning engine 224 may have instructions that direct and/or cause recommendation computing platform 200 to determine, via a media ML model and based on unstructured media data from a media platform, a plurality of media features, as discussed in greater detail below. For example, the unstructured media data may comprise a social media post, including an image with one or more objects in the image and various parameters associated with the social media post. The media ML model classifies each of the one or more objects in the image as a keyword (i.e. a product name). Then, the media ML model extracts the parameters associated with the social media post as media features and associates the media features with the keyword. In some embodiments, the media features associated with the social media post may include, but is not limited to, the number of views of the social media post, the number of event interactions of the social media post (i.e. clicks to URL links and the like), the number of sales of a product generated from the social media post, the name of the social media or online marketplace account generating the social media post, the text displayed in the social media post, the date (day, month, and year) of the social media post, the time (measured in periods of seconds, minutes, hours, or years), and/or the like.

Recommendation machine learning engine 226 may have instructions that direct and/or cause recommendation computing platform 200 to determine, via a recommendation ML model and based on the plurality of account features and the plurality of media features, a recommendation score based on each of the plurality of media features matching with any of the plurality of account features, discussed in greater detail below. In some embodiments, recommendation machine learning engine 226 may have instructions that direct and/or cause recommendation computing platform 200 to generate tokens for each of the plurality of account features and the plurality of media features, where the tokens are connected together in a fully connected graph structure. In some embodiments, machine learning engine 226 may have instructions that direct and/or cause recommendation computing platform 200 to delete each of the tokens representing each of the plurality of media features not matching with any of the tokens representing each of the plurality of account features. Recommendation generation engine 228 may have instructions that direct and/or cause recommendation computing platform 200 to process a recommendation score based on the tokens in the fully connected graph structure representing the plurality of account features and the plurality of media features. Recommendation generation engine 228 may have instructions that direct and/or cause recommendation computing platform 200 to generate a recommendation for the user account based on the recommendation score and send the recommendation to a user computing device associated with the user account. In some embodiments, recommendation generation engine 228 may have instructions that direct and/or cause recommendation computing platform 200 to modify the recommendation for the user account based on one or more events that may impact the recommendation and location information associated with the user account.

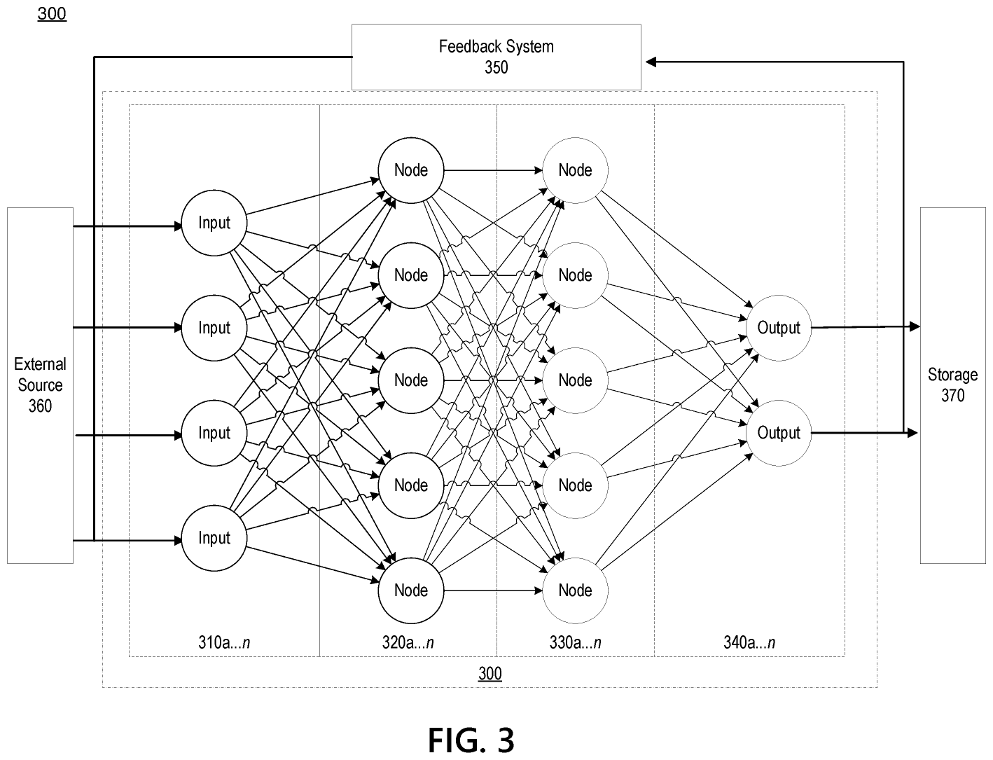

FIG. 3 illustrates a simplified example of an artificial neural network 300 on which a machine learning algorithm may be executed. FIG. 3 is merely an example of nonlinear processing using an artificial neural network; other forms of nonlinear processing may be used to implement a machine learning algorithm in accordance with features described herein.

By way of background, a framework for machine learning algorithm may involve a combination of one or more components, sometimes three components: (1) representation, (2) evaluation, and (3) optimization components. Representation components refer to computing units that perform steps to represent knowledge in different ways, including but not limited to as one or more decision trees, sets of rules, instances, graphical models, neural networks, support vector machines, model ensembles, and/or others. Evaluation components refer to computing units that perform steps to represent the way hypotheses (e.g., candidate programs) are evaluated, including but not limited to as accuracy, prediction and recall, squared error, likelihood, posterior probability, cost, margin, entropy k-L divergence, and/or others. Optimization components refer to computing units that perform steps that generate candidate programs in different ways, including but not limited to combinatorial optimization, convex optimization, constrained optimization, and/or others. In some embodiments, other components and/or sub-components of the aforementioned components may be present in the system to further enhance and supplement the aforementioned machine learning functionality.

Machine learning algorithms sometimes rely on unique computing system structures. Machine learning algorithms may leverage neural networks, which are systems that approximate biological neural networks (e.g., the human mind). Such structures, while significantly more complex than conventional computer systems, are beneficial in implementing machine learning. For example, an artificial neural network may be comprised of a large set of nodes which, like neurons in humans, may be dynamically configured to effectuate learning and decision-making.

Machine learning tasks are sometimes broadly categorized as either unsupervised learning or supervised learning. In unsupervised learning, a machine learning algorithm is left to generate any output (e.g., to label as desired) without feedback. The machine learning algorithm may teach itself (e.g., observe past output), but otherwise operates without (or mostly without) feedback from, for example, a human administrator. An embodiment involving unsupervised machine learning is described herein.

Meanwhile, in supervised learning, a machine learning algorithm is provided feedback on its output. Feedback may be provided in a variety of ways, including via active learning, semi-supervised learning, and/or reinforcement learning. In active learning, a machine learning algorithm is allowed to query answers from an administrator. For example, the machine learning algorithm may make a guess in a face detection algorithm, ask an administrator to identify the photo in the picture, and compare the guess and the administrator's response. In semi-supervised learning, a machine learning algorithm is provided a set of example labels along with unlabeled data. For example, the machine learning algorithm may be provided a data set of photos with labeled human faces and 10,000 random, unlabeled photos. In reinforcement learning, a machine learning algorithm is rewarded for correct labels, allowing it to iteratively observe conditions until rewards are consistently earned. For example, for every face correctly identified, the machine learning algorithm may be given a point and/or a score (e.g., “75% correct”). An embodiment involving supervised machine learning is described herein.

One theory underlying supervised learning is inductive learning. In inductive learning, a data representation is provided as input samples data (x) and output samples of the function (f(x)). The goal of inductive learning is to learn a good approximation for the function for new data (x), i.e., to estimate the output for new input samples in the future. Inductive learning may be used on functions of various types: (1) classification functions where the function being learned is discrete; (2) regression functions where the function being learned is continuous; and (3) probability estimations where the output of the function is a probability.

As elaborated herein, in practice, machine learning systems and their underlying components are tuned by data scientists to perform numerous steps to perfect machine learning systems. The process is sometimes iterative and may entail looping through a series of steps: (1) understanding the domain, prior knowledge, and goals; (2) data integration, selection, cleaning, and pre-processing; (3) learning models; (4) interpreting results; and/or (5) consolidating and deploying discovered knowledge. This may further include conferring with domain experts to refine the goals and make the goals more clear, given the nearly infinite number of variables that can possible be optimized in the machine learning system. Meanwhile, one or more of data integration, selection, cleaning, and/or pre-processing steps can sometimes be the most time consuming because the old adage, “garbage in, garbage out,” also reigns true in machine learning systems.

In FIG. 3, each of input nodes 310a-n is connected to a first set of processing nodes 320a-n. Each of the first set of processing nodes 320a-n is connected to each of a second set of processing nodes 330a-n. Each of the second set of processing nodes 330a-n is connected to each of output nodes 340a-n. Though only two sets of processing nodes are shown, any number of processing nodes may be implemented. Similarly, though only four input nodes, five processing nodes, and two output nodes per set are shown in FIG. 3, any number of nodes may be implemented per set. Data flows in FIG. 3 are depicted from left to right: data may be input into an input node, may flow through one or more processing nodes, and may be output by an output node. Input into the input nodes 310a-n may originate from an external source 360. Output may be sent to a feedback system 350 and/or to storage 370. The feedback system 350 may send output to the input nodes 310a-n for successive processing iterations with the same or different input data.

In one illustrative method using feedback system 350, the system may use machine learning to determine an output. The output may include anomaly scores, heat scores/values, confidence values, and/or classification output. The system may use any machine learning model including xgboosted decision trees, auto-encoders, perceptron, decision trees, support vector machines, regression, and/or a neural network. The neural network may be any type of neural network including a feed forward network, radial basis network, recurrent neural network, long/short term memory, gated recurrent unit, auto encoder, variational autoencoder, convolutional network, residual network, Kohonen network, and/or other type. In one example, the output data in the machine learning system may be represented as multi-dimensional arrays, an extension of two-dimensional tables (such as matrices) to data with higher dimensionality.

The neural network may include an input layer, a number of intermediate layers, and an output layer. Each layer may have its own weights. The input layer may be configured to receive as input one or more feature vectors described herein. The intermediate layers may be convolutional layers, pooling layers, dense (fully connected) layers, and/or other types. The input layer may pass inputs to the intermediate layers. In one example, each intermediate layer may process the output from the previous layer and then pass output to the next intermediate layer. The output layer may be configured to output a classification or a real value. In one example, the layers in the neural network may use an activation function such as a sigmoid function, a Tanh function, a ReLu function, and/or other functions. Moreover, the neural network may include a loss function. For example, when training the neural network, the output of the output layer may be used as a prediction and may be compared with a target value of a training instance to determine an error. The error may be used to update weights in each layer of the neural network.

In one example, the neural network may include a technique for updating the weights in one or more of the layers based on the error. The neural network may use gradient descent to update weights. Alternatively, the neural network may use an optimizer to update weights in each layer. For example, the optimizer may use various techniques, or combination of techniques, to update weights in each layer. When appropriate, the neural network may include a mechanism to prevent overfitting—regularization (such as L1 or L2), dropout, and/or other techniques. The neural network may also increase the amount of training data used to prevent overfitting.

Once data for machine learning has been created, an optimization process may be used to transform the machine learning model. The optimization process may include (1) training the data to predict an outcome, (2) defining a loss function that serves as an accurate measure to evaluate the machine learning model's performance. (3) minimizing the loss function, such as through a gradient descent algorithm or other algorithms, and/or (4) optimizing a sampling method, such as using a stochastic gradient descent (SGD) method where instead of feeding an entire dataset to the machine learning algorithm for the computation of each step, a subset of data is sampled sequentially.

In one example, FIG. 3 depicts nodes that may perform various types of processing, such as discrete computations, computer programs, and/or mathematical functions implemented by a computing device. For example, the input nodes 310a-n may comprise logical inputs of different data sources, such as one or more data servers. The processing nodes 320a-n may comprise parallel processes executing on multiple servers in a data center. And, the output nodes 340a-n may be the logical outputs that ultimately are stored in results data stores, such as the same or different data servers as for the input nodes 310a-n. Notably. the nodes need not be distinct. For example, two nodes in any two sets may perform the exact same processing. The same node may be repeated for the same or different sets.

Each of the nodes may be connected to one or more other nodes. The connections may connect the output of a node to the input of another node. A connection may be correlated with a weighting value. For example, one connection may be weighted as more important or significant than another, thereby influencing the degree of further processing as input traverses across the artificial neural network. Such connections may be modified such that the artificial neural network 300 may learn and/or be dynamically reconfigured. Though nodes are depicted as having connections only to successive nodes in FIG. 3, connections may be formed between any nodes. For example, one processing node may be configured to send output to a previous processing node.

Input received in the input nodes 310a-n may be processed through processing nodes, such as the first set of processing nodes 320a-n and the second set of processing nodes 330a-n. The processing may result in output in output nodes 340a-n. As depicted by the connections from the first set of processing nodes 320a-n and the second set of processing nodes 330a-n, processing may comprise multiple steps or sequences. For example, the first set of processing nodes 320a-n may be a rough data filter, whereas the second set of processing nodes 330a-n may be a more detailed data filter.

The artificial neural network 300 may be configured to effectuate decision-making. As a simplified example for the purposes of explanation, the artificial neural network 300 may be configured to detect objects in photographs. The input nodes 310a-n may be provided with a digital copy of a photograph. The first set of processing nodes 320a-n may be each configured to perform specific steps to remove non-object content, such as large contiguous sections of the color blue in the background of the photograph. The second set of processing nodes 330a-n may be each configured to look for rough approximations of objects, such as object shapes and color tones. Multiple subsequent sets may further refine this processing, each looking for further more specific tasks, with each node performing some form of processing which need not necessarily operate in the furtherance of that task. The artificial neural network 300 may then predict the location and/or label (i.e. what kind of object) of the object in the photograph. The prediction may be correct or incorrect.

The feedback system 350 may be configured to determine whether or not the artificial neural network 300 made a correct decision. Feedback may comprise an indication of a correct answer and/or an indication of an incorrect answer and/or a degree of correctness (e.g., a percentage). For example, in the object recognition example provided above, the feedback system 350 may be configured to determine if the object was correctly identified and, if so, what percentage of the object was correctly identified. The feedback system 350 may already know a correct answer, such that the feedback system may train the artificial neural network 300 by indicating whether it made a correct decision. The feedback system 350 may comprise human input, such as an administrator telling the artificial neural network 300 whether it made a correct decision. The feedback system may provide feedback (e.g., an indication of whether the previous output was correct or incorrect) to the artificial neural network 300 via input nodes 310a-n or may transmit such information to one or more nodes. The feedback system 350 may additionally or alternatively be coupled to the storage 370 such that output is stored. The feedback system may not have correct answers at all, but instead base feedback on further processing: for example, the feedback system may comprise a system programmed to identify objects, such that the feedback allows the artificial neural network 300 to compare its results to that of a manually programmed system.

The artificial neural network 300 may be dynamically modified to learn and provide better input. Based on, for example, previous input and output and feedback from the feedback system 350, the artificial neural network 300 may modify itself. For example, processing in nodes may change and/or connections may be weighted differently. Following on the example provided previously, the object prediction may have been incorrect because the photos provided to the algorithm were tinted in a manner which made all objects look blue. As such, the node which excluded sections of photos containing large contiguous sections of the color blue could be considered unreliable, and the connections to that node may be weighted significantly less. Additionally, or alternatively, the node may be reconfigured to process photos differently. The modifications may be predictions and/or guesses by the artificial neural network 300, such that the artificial neural network 300 may vary its nodes and connections to test hypotheses.

The artificial neural network 300 need not have a set number of processing nodes or number of sets of processing nodes, but may increase or decrease its complexity. For example, the artificial neural network 300 may determine that one or more processing nodes are unnecessary or should be repurposed, and either discard or reconfigure the processing nodes on that basis. As another example, the artificial neural network 300 may determine that further processing of all or part of the input is required and add additional processing nodes and/or sets of processing nodes on that basis.

The feedback provided by the feedback system 350 may be mere reinforcement (e.g., providing an indication that output is correct or incorrect, awarding the machine learning algorithm a number of points, or the like) or may be specific (e.g., providing the correct output). For example, the machine learning algorithm 300 may be asked to detect faces in photographs. Based on an output, the feedback system 350 may indicate a score (e.g., 75% accuracy, an indication that the guess was accurate, or the like) or a specific response (e.g., specifically identifying where the face was located).

The artificial neural network 300 may be supported or replaced by other forms of machine learning. For example, one or more of the nodes of artificial neural network 300 may implement a decision tree, associational rule set, logic programming, regression model, cluster analysis mechanisms, Bayesian network, propositional formulae, generative models, and/or other algorithms or forms of decision-making. The artificial neural network 300 may effectuate deep learning.

In another example, an unsupervised machine learning engine may use an autoencoder technique to detect anomalies within the graph. The autoencoder may be constructed with a number of layers that represent the encoding portion of the network and a number of layers that represent the decoding portion of the network. The encoding portion of the network may output a vector representation of inputs into the encoder network, and the decoding portion of the network may receive as input a vector representation generated by the encoding portion of the network. It may then use the vector representation to recreate the input that the encoder network used to generate the vector representation.

The autoencoder may be trained on historical data or feature vectors that are known to not be fraudulent. By training on non-fraudulent feature vectors, the autoencoder may learn how a non-fraudulent entity behaves. When the autoencoder encounters a feature vector that is different from the feature vectors it has trained on, the unsupervised machine learning engine may flag the feature vector as potentially fraudulent.

The autoencoder may be a variational autoencoder, in some examples. The variational autoencoder may include the components of the autoencoder. The variational autoencoder may also include a constraint on its encoding network that forces it to generate vector representations of inputs according to a distribution (e.g., a unit Gaussian distribution).

In yet another example, attention layers and positional embeddings may be used in a sophisticated neural network architecture called a transformer. A multi-head attention layer and masked multi-head attention layer are some of the key features of a transformer that enables it to assist in generating recommendations. The inputs and outputs, attention layers, and feed forwards of the transformer are configured to receive two types of inputs: (1) a plurality of account features, and (2) a plurality of media features. In one example, the plurality of account features and the plurality of media features are tokenized and embedded as tokens into a fully connected graph structure (e.g., the tokens are nodes in the fully connected graph) to minimize any differences or constraints between the different types of features. Various tasks such as classification, masking, matching, and ordering may be performed more easily on the tokenized fully connected graph by having the different types of features in a similar format. Moreover, the transformer may leverage positional encoding and multi-head attention layers (e.g., masked multi-head attention layers), to output probabilities—i.e., the whether a media feature matches with a account feature for the predictive model to perform feature engineering to generate a recommendation score. The media features not matching any of the account features may be deleted from the fully connected graph to limit the number of nodes in the graph, optimizing the generation of the recommendation score.

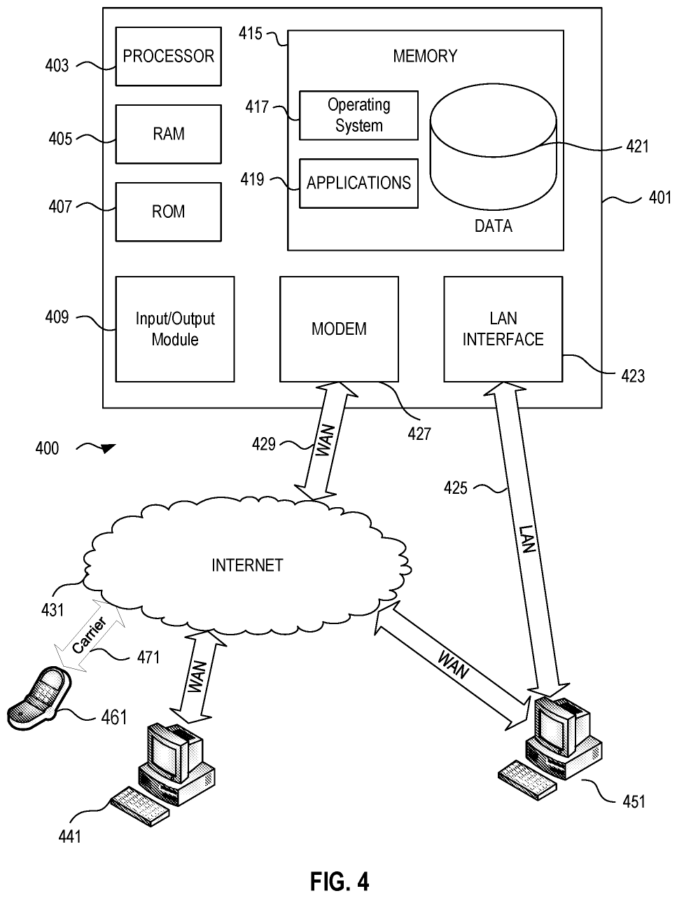

FIG. 4 illustrates an example of a computing system environment 400 that may be used according to one or more illustrative embodiments. The computing system environment 400 is only one example of a suitable computing environment and is not intended to suggest any limitation as to the scope of use or functionality contained in the disclosure. The computing system environment 400 should not be interpreted as having any dependency or requirement relating to any one or combination of components shown in the computing system environment 400.

The disclosure is operational with numerous other general purpose or special purpose computing system environments or configurations. Examples of well known computing systems, environments, and/or configurations that may be suitable for use with the disclosed embodiments include, but are not limited to, personal computers (PCs), server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

With reference to FIG. 4, the computing system environment 400 may include a computing device 401 wherein the processes discussed herein may be implemented. The computing device 401 may have a processor 403 for controlling overall operation of the computing device 401 and its associated components, including random-access memory (RAM) 405, read-only memory (ROM) 407, input/output module or communications module 409, and memory 415. Computing device 401 typically includes a variety of computer readable media. Computer readable media may be any available media that may be accessed by computing device 401 and include both volatile and nonvolatile media, removable and non-removable media. By way of example, and not limitation, computer readable media may comprise a combination of computer storage media and communication media.

Computer storage media include volatile and nonvolatile, removable and non-removable media implemented in any method or technology for storage of information such as computer readable instructions, data structures, program modules or other data. Computer storage media include, but is not limited to, random access memory (RAM), read only memory (ROM), electronically erasable programmable read only memory (EEPROM), flash memory or other memory technology, CD-ROM, digital versatile disks (DVD) or other optical disk storage, magnetic cassettes, magnetic tape, magnetic disk storage or other magnetic storage devices, or any other medium that can be used to store the desired information and that can be accessed by computing device 401.

Communication media typically embodies computer readable instructions, data structures, program modules or other data in a modulated data signal such as a carrier wave or other transport mechanism and includes any information delivery media. Modulated data signal includes a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Computing system environment 400 may also include optical scanners (not shown). Exemplary usages include scanning and converting paper documents, e.g., correspondence, receipts to digital files.

Although not shown, RAM 405 may include one or more applications representing the application data stored in RAM 405, while the computing device is on and corresponding software applications (e.g., software tasks) are running on the computing device 401.

Communications module 409 may include a microphone, keypad, touch screen, and/or stylus through which a user of computing device 401 may provide input, and may also include one or more of a speaker for providing audio output and a video display device for providing textual, audiovisual and/or graphical output.

Software may be stored within memory 415 and/or storage to provide instructions to processor 403 for enabling computing device 401 to perform various functions. For example, memory 415 may store software used by the computing device 401, such as an operating system 417, application programs 419, and an associated database 421. Also, some or all of the computer executable instructions for computing device 401 may be embodied in hardware or firmware.

Computing device 401 may operate in a networked environment supporting connections to one or more remote computing devices, such as computing devices 441, 451, and 461. The computing devices 441, 451, and 461 may be personal computing devices or servers that include many or all of the elements described above relative to the computing device 401. Computing device 461 may be a mobile device communicating over wireless carrier channel 471.

The network connections depicted in FIG. 4 include a local area network (LAN) 425 and a wide area network (WAN) 429, but may also include other networks. When used in a LAN networking environment, computing device 401 may be connected to the LAN 425 through a network interface, such as LAN interface 423, or to an adapter in the communications module 409. When used in a WAN networking environment, the computing device 401 may include a modem in the communications module 409, a modem separate from the communications module 409, such as modem 427, or other means for establishing communications over the WAN 429, such as the Internet 431 or other type of computer network. It will be appreciated that the network connections shown are illustrative and other means of establishing a communication link between the computing devices may be used. Various well-known protocols such as TCP/IP, Ethernet, FTP, HTTP and the like may be used, and the system can be operated in a client-server or in Distributed Computing configuration to permit a user to retrieve web pages from a web-based server. Any of various conventional web browsers can be used to display and manipulate data on web pages.

Additionally, one or more application programs 419 used by the computing device 401, according to an illustrative embodiment, may include computer executable instructions for invoking user functionality related to communication including, for example, email, short message service (SMS), and voice input and speech recognition applications.

Embodiments of the disclosure may include forms of computer-readable media. Computer-readable media include any available media that can be accessed by a computing device 401. Computer-readable media may comprise storage media and communication media and in some examples may be non-transitory. Storage media include volatile and nonvolatile, removable and non-removable media implemented in any method or technology for storage of information such as computer-readable instructions, object code, data structures, program modules, or other data. Communication media include any information delivery media and typically embody data in a modulated data signal such as a carrier wave or other transport mechanism.

Although not required, various aspects described herein may be embodied as a method, a data processing system, or a computer-readable medium storing computer-executable instructions. For example, a computer-readable medium storing instructions to cause a processor to perform steps of a method in accordance with aspects of the disclosed embodiments is contemplated. For example, aspects of the method steps disclosed herein may be executed on a processor on a computing device 401. Such a processor may execute computer-executable instructions stored on a computer-readable medium. In an example, the systems and apparatus described herein may correspond to the computing device 401. A computer-readable medium (e.g., ROM 407) may store instructions that, when executed by the processor 403, may cause the computing device 401 to perform the functions as described herein.

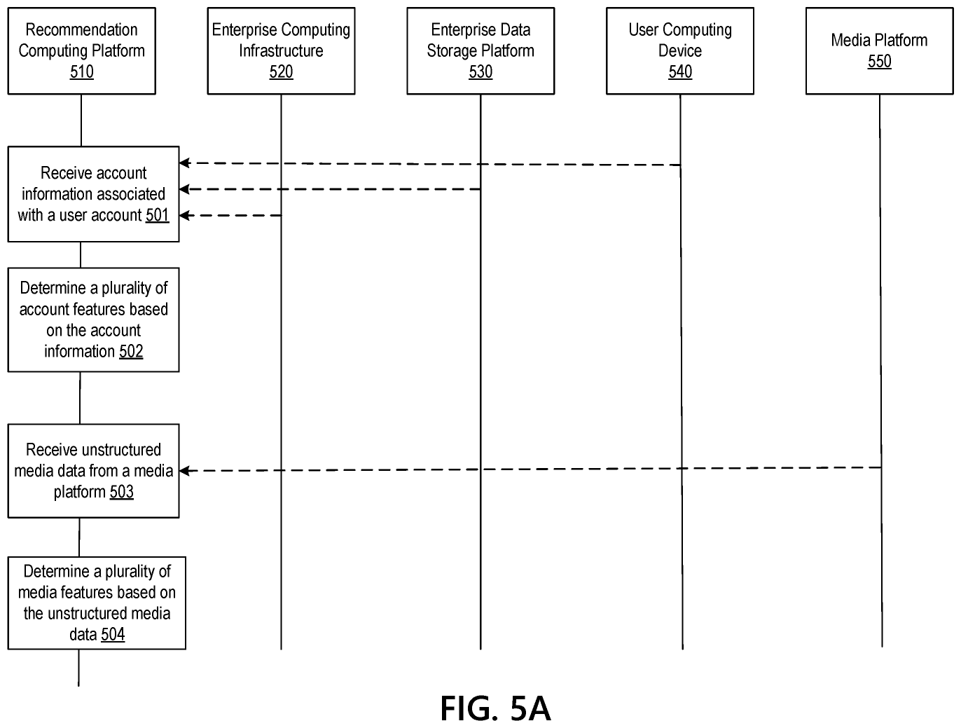

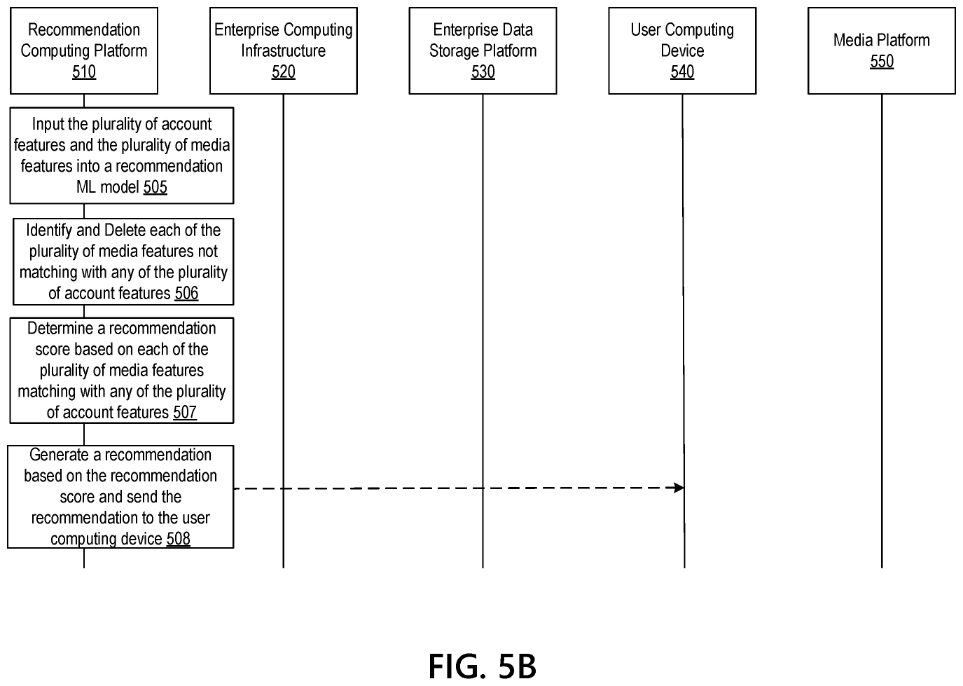

FIGS. 5A and 5B depict an illustrative event sequence in accordance with one or more illustrative aspects described herein. Referring to FIG. 5A, at step 501, a recommendation computing platform 510 may receive account information associated with a user account of an enterprise organization customer. The account information associated with the user account may comprise historical account data and one or more user-defined account rules. The account information may be sent and stored by the enterprise computing infrastructure 520, the enterprise data storage platform 530, or the user computing device 540 and/or a combination of the enterprise computing infrastructure 520, the enterprise data storage platform 530, or the user computing device 540. In some embodiments, the historical account data includes records of credit card payments, utility bill payments, mortgage payments, advertising and/or marketing payments for products and services, deposits from sales of various products and services, income activity, and the like. In some embodiments, the one or more user-defined account rules comprise one or more rules associated with an automatic loan amount, a secondary funding source, automatic payment options, a budget for a specific period of time, a designated alternate decision making authority, and/or preferred communication channels. For example, a budget for a specific period of time may include various categories with each category allocated a threshold value including, but not limited to, credit card payments, utility bill payments, mortgage payments, advertising and/or marketing payments, and the like.

At step 502, the account information may be input into a user ML model to determine a plurality of account features based on the account information comprising the historical account data and the one or more user-defined account rules. In some embodiments, the user ML model is an artificial neural network trained on the historical account data and one or more user-defined account rules to determine a plurality of account features. For example, the user ML model may use a clustering algorithm to cluster account data associated with deposits from sales of a product (i.e. a necklace, a ring, etc.) and account data associated with advertising payments for the product. The clustering may be done by classifying account data based on keywords (i.e. the product name or the transaction name) in the account data. Then, account features in a cluster of account data associated with a keyword are extracted. The account features may include categorical features as variables used to map input and output data in the user ML model. In one example, the account features are extracted using principal component analysis. The plurality of account features may include transaction features for a first product (a necklace) and transaction features for a second product (a ring). Additionally, or alternatively, the user ML model may have weights set by the one or more user-defined account rules such as a budget for a specific period of time including threshold values for various transactions.

At step 503, the recommendation computing platform 510 receives unstructured media data from a media platform 550. In some embodiments the media platform 550 is a social media platform and/or an online marketplace. The unstructured media data may comprise textual data, image data, video data, and/or audio data and the like. For example, the unstructured media data may be a social media post advertising a product including image data and textual data. The unstructured media data may also include a plurality of social media posts. In another example, the unstructured media data is a plurality of online marketplace listings offering various products for sale. The social media posts or online marketplace listings are created by the user of the enterprise organization to promote and/or sell their product.

In one embodiment, the unstructured media data is communicated from the media platform 550 to the recommendation computing platform 510 using a RESTful or REST (Representational State Transfer) Application programming interface (API). The REST API uses the hypertext transfer protocol (HTTP) and is provided by the media platform 550 for media platform users to Create, Read, Update, and Delete data from media platform resources. For example, the recommendation platform 510 may use the REST API to request a read function to retrieve unstructured media data on the media platform 550 representing a social media post promoting a product. The information or data retrieved from the media platform may be in various formats including, but not limited to, JavaScript Object Notation (JSON), hypertext markup language (HTML), extensible markup language (XML), Python, Hypertext Preprocessor (PHP) or plain text.

In another embodiment, the unstructured media data is communicated from the media platform 550 to the recommendation computing platform 510 using custom data scraping (or web scraping) tools developed by an enterprise organization. The custom data scraping tools collect content or data from publicly available webpages on the internet using an HTTP protocol and the like. The data scraping tools use automated techniques to extract data from webpages in HTML or XML format. In some examples, the data scraping tools may also extract cascading style sheets (CSS) and JavaScript data as well. In some embodiments, the data scraping tools comprise a crawler module and a scraper module. The crawler module is provided with uniform resource locators (URLs) of websites to access various webpages. Once a webpage is accessed, the scraper module may extract or scrape data from the webpage. The scraper module may be programmed to only extract specific data by parsing HTML or XML tree structures nested with different kinds of data. For example, the custom data scraping tool may have a scraper module programmed to only extract data associated with an online marketplace listing of a product, but not to extract data associated with reviews of the product at the bottom of a webpage.

At step 504, the unstructured media data is input into a media ML model to determine a plurality of media features based on the unstructured media data. In some embodiments, the media ML model is a convolutional neural network trained on a plurality of unstructured media data. In some embodiments, the media ML model classifies objects in images or videos as keywords associated with various media parameters of the unstructured media data. For example, the unstructured media data may comprise a social media post, including an image with one or more objects in the image and various media parameters associated with the social media post. The media ML model classifies each of the one or more objects in the image as a keyword (i.e. a product name). Then, the media ML model extracts the parameters associated with the social media post as media features and associates the media features with the keyword. In some embodiments, the media features associated with the social media post may include, but is not limited to, the number of views of the social media post, the number of event interactions of the social media post (i.e. clicks to URL links and the like), the number of sales of a product generated from the social media post, the name of the social media or online marketplace account generating the social media post, the text displayed in the social media post, the date (day, month, and year) of the social media post, the time (measured in periods of seconds, minutes, hours, or years), and/or the like.

Referring to FIG. 5B, at step 505, the plurality of account features and the plurality of media features are input into a recommendation ML model. In some embodiments, the recommendation ML model is a transformer trained on a plurality of account features and a plurality of media features. The inputs and outputs, attention layers, and feed forwards of the transformer are configured to receive two types of inputs: (1) a plurality of account features, and (2) a plurality of media features. In one example, the plurality of account features and the plurality of media features are tokenized and embedded as tokens into a fully connected graph structure (the tokens act as nodes in the fully connected graph) to minimize any differences or constraints between the different types of features. Various tasks such as classification, masking, matching, and ordering may be performed more easily on the tokenized fully connected graph by having the different types of features in a similar format. Moreover, the transformer may leverage positional encoding and multi-head attention layers (e.g., masked multi-head attention layers), to output probabilities—i.e., the whether a token representing a media feature matches with a token representing an account feature for the predictive model to perform feature engineering to generate a recommendation score. The tokens representing media features not matching any of the tokens representing account features will be deleted from the fully connected graph to limit the number of nodes in the graph, optimizing the generation of the recommendation score.

At step 506, the recommendation ML model identifies and deletes each of the plurality of media features not matching any of the plurality of account features. The identification of a match between a media feature and a account feature is accomplished by comparing the keyword associated with a media feature and the keyword associated with an account feature to determine if the keywords match. In some embodiments, tokens representing each of the plurality of media features not matching any of the plurality of account features are deleted from a fully connected graph structure connecting the tokens together.

At step 507, the recommendation model determines and outputs a recommendation score based on each of the plurality of media features matching with any of the plurality of account features. For example, the recommendation score is determined by processing tokens representing each of the media features and account features associated with the same keyword (or product name). The media features may represent parameters such as the number of views of a social media post, the number of event interactions of a social media post (i.e. clicks to URL links and the like), and the number of sales of a product generated from a social media post. The account features may represent account data such as deposits from sales of a product (i.e. a necklace, a ring, etc.) and account data associated with advertising payments for the product. The recommendation score may comprise a numerical value representing a recommendation to increase or decrease spending on advertisements for a product based on the tokens representing the media features and account features associated with the same keyword (or product name). In another example, the recommendation score may comprise a numerical value representing a recommendation to open a small business account at an enterprise organization and/or a line of credit by recognizing a new business and/or a new product offered by a small business

At step 508, the recommendation computing platform 510 generates a recommendation based on the recommendation score and sends the recommendation to the user computing device 540 associated with the user account. In some embodiments, the recommendation is sent to the user computing device in a text message, e-mail message, or a push notification message. In other embodiments, the recommendation computing platform 510 retrieves, from one or more external sources of data, one or more events that may impact the recommendation and location information associated with the user account. Then, the recommendation computing platform 510 modifies the recommendation for the user account based on the one or more events that may impact the recommendation and the location information. The one or more events may comprise a weather-related event, an employment related event, a geopolitical event, and a civic unrest event.

In some embodiments, the recommendation comprises an action for the user account to open a small business account, open a checking account, open a savings account, apply for a credit card, and open a line of credit. In other embodiments, the recommendation comprises an action for the user account to decrease spending on a transaction, increase spending on a transaction, and modify a budget for a specific period of time.

In other embodiments, the user computing device executes an action on the user account based on the recommendation. In some embodiments, the action on the user account comprises at least one of open a small business account, open a checking account, open a savings account, apply for a credit card, or open a line of credit, or a combination thereof. In some embodiments, the action on the user account comprises at least one of decrease spending on a transaction, increase spending on a transaction, or modify a budget for a specific period of time, or a combination thereof.

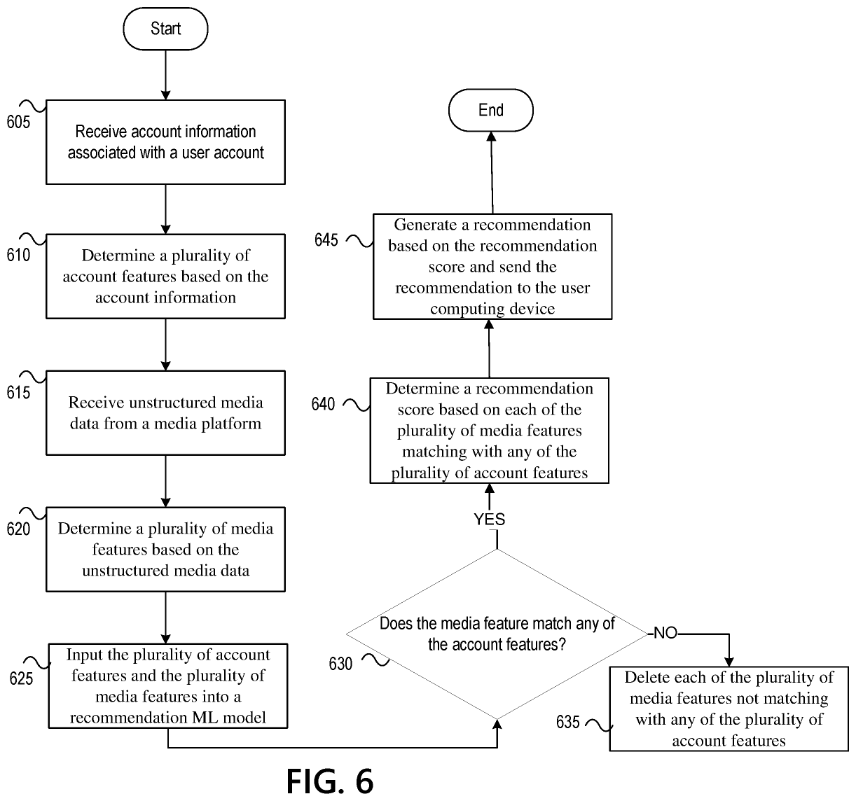

FIG. 6 shows an illustrative flowchart in accordance one or more illustrative aspects described herein. Referring to FIG. 6, at step 605, a recommendation computing platform having at least one processor and memory, may receive account information associated with a user account. The account information associated with the user account comprises historical account data and one or more user-defined account rules. At step 610, the account information may be input into a user ML model to determine a plurality of account features based on the account information comprising the historical account data and the one or more user-defined account rules. At step 615, the recommendation computing platform receives unstructured media data from a media platform. At step 620, the unstructured media data is input into a media ML model to determine a plurality of media features based on the unstructured media data. At step 625, the plurality of account features and the plurality of media features are input into a recommendation ML model.

At step 630, if a media feature does not match any of the plurality of account features, then proceed to step 635. At step 635, delete each of the plurality of media features not matching with any of the plurality of account features. If the media feature does match any of the plurality of account features, then proceed to step 640. In one example, the identification of a match between a media feature and a account feature is accomplished by comparing the keyword associated with a media feature and the keyword associated with an account feature to determine if the keywords match.

At step 640, determine a recommendation score based each of the plurality of media features matching with any of the plurality of account features and output the recommendation score via the recommendation ML model. At step 645, the recommendation computing platform generates a recommendation based on the recommendation score and sends the recommendation to the user computing device associated with the user account.

Although the subject matter has been described in language specific to structural features and/or methodological acts, it is to be understood that the subject matter defined in the appended claims is not necessarily limited to the specific features or acts described above. Rather, the specific features and acts described above are described as example implementations of the following claims. One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally, or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A computing platform for enhanced generation of a recommendation for a user account, using machine learning (ML) to process unstructured media data from a media platform and account information associated with the user account to determine the recommendation, comprising:
at least one processor; and
memory storing computer-readable instructions that, when executed by the at least one processor, cause the computing platform to:
receive the account information, wherein the account information comprises historical account data and one or more user-defined account rules;
input, into a user ML model, the account information;
process, by the user ML model, the historical account data and the one or more user-defined account rules to determine a plurality of account features;
output, by the user ML model, the plurality of account features;
receive, from the media platform, unstructured media data, wherein the unstructured media data comprises objects and media parameters;
input, into a media ML model, the unstructured media data, wherein the media ML model is a convolutional neural network;
classify, by the media ML model, the objects in the unstructured media data as keywords associated with the media parameters to determine a plurality of media features;
output, by the media ML model, the plurality of media features;
input, into a recommendation ML model, the plurality of account features and the plurality of media features;
generate, by the recommendation ML model, tokens representing each of the plurality of media features and each of the plurality of account features, wherein the tokens are connected together in a fully connected graph structure;
delete, by the recommendation ML model, each of the tokens representing media features not matching with any of the tokens representing the plurality of account features;
process, by the recommendation ML model, a recommendation score based on the tokens in the fully connected graph structure representing the plurality of account features and the plurality of media features;
output, by the recommendation ML model, the recommendation score;
generate the recommendation for the user account based on the recommendation score; and
send, to a user computing device associated with the user account, the recommendation
execute, by the user computing device, an action on the user account based on the recommendation.

2. The computing platform of claim 1, wherein the memory stores additional computer-readable instructions that, when executed by the at least one processor, cause the computing platform to:
train the user ML model based on the historical account data and one or more user-defined account rules to determine the plurality of account features.

3. The computing platform of claim 1, wherein the memory stores comprise additional computer-readable instructions that, when executed by the at least one processor, cause the computing platform to:
train the media ML model based on a plurality of unstructured media data to determine the plurality of media features.

4. The computing platform of claim 1, wherein the memory stores additional computer-readable instructions that, when executed by the at least one processor, cause the computing platform to:
train the recommendation ML model based on the plurality of account features and the plurality of media features to determine the recommendation score.

5. The computing platform of claim 1, wherein the recommendation is sent to the user computing device in a text message, e-mail message, or a push notification message.

6. The computing platform of claim 1, wherein the media platform comprises at least one of a social media platform or an online marketplace, or a combination thereof.

7. The computing platform of claim 1, wherein the memory stores additional computer-readable instructions that, when executed by the at least one processor, cause the computing platform to:
retrieve, from one or more external sources of data, one or more events that may impact the recommendation and location information associated with the user account; and
modify the recommendation for the user account based on the one or more events that may impact the recommendation and the location information.

8. The computing platform of claim 4, wherein the one or more events comprise at least one of a weather-related event, an employment related event, a geopolitical event, or a civic unrest event, or a combination thereof.

9. The computing platform of claim 1, wherein the unstructured media data comprises at least one of textual data, image data, audio data, or video data, or a combination thereof.

10. The computing platform of claim 1, wherein the one or more user-defined account rules comprise at least one or more rules associated with an automatic loan amount, a secondary funding source, automatic payment options, a budget for a specific period of time, a designated alternate decision making authority, or preferred communication channels, or a combination thereof.

11. The computing platform of claim 1, wherein the action on the user account comprises at least one of open a small business account, open a checking account, open a savings account, apply for a credit card, or open a line of credit, or a combination thereof.

12. The computing platform of claim 1, wherein the action on the user account comprises at least one of decrease spending on a transaction, increase spending on a transaction, or modify a budget for a specific period of time, or a combination thereof.

13. A method for enhanced generation of a recommendation for a user account, using multiple machine learning (ML) models, comprising:
at a computing platform comprising at least one processor, and memory:
receiving account information associated with the user account, wherein the account information comprises historical account data and one or more user-defined account rules;
inputting, into a user ML model, the account information;
processing, by the user ML model, the historical account data and the one or more user-defined account rules to determine a plurality of account features;
outputting, by the user ML model, the plurality of account features;
receiving, from a media platform, unstructured media data;
inputting, into a media ML model, the unstructured media data;
processing, by the media ML model, the unstructured media data to determine a plurality of media features;
outputting, by the media ML model, the plurality of media features;
inputting, into a recommendation ML model, the plurality of account features and the plurality of media features;
generating, by the recommendation ML model, tokens representing each of the plurality of media features and each of the plurality of account features, wherein the tokens are connected together in a fully connected graph structure;
deleting, by the recommendation ML model, each of the tokens representing media features not matching with any of the tokens representing the plurality of account features;
processing, by the recommendation ML model, a recommendation score based on the tokens in the fully connected graph structure representing the plurality of account features and the plurality of media features;
outputting, by the recommendation ML model, the recommendation score;
generating the recommendation for the user account based on the recommendation score; and
sending, to a user computing device associated with the user account, the recommendation.

14. The method of claim 13, further comprising:
training the user ML model based on the historical account data and one or more user-defined account rules to determine the plurality of account features.

15. The method of claim 13, further comprising:
training the media ML model based on a plurality of unstructured media data to determine the plurality of media features.

16. The method of claim 13, further comprising:
training the recommendation ML model based on the plurality of account features and the plurality of media features to determine the recommendation score.

17. The method of claim 13, wherein the one or more user-defined account rules comprise at least one or more rules associated with an automatic loan amount, a secondary funding source, automatic payment options, a budget for a specific period of time, a designated alternate decision making authority, or preferred communication channels, or a combination thereof.

18. The method of claim 13, wherein the recommendation comprises at least one of an action for the user account to open a small business account, open a checking account, open a savings account, apply for a credit card, or open a line of credit, or a combination thereof.

19. The method of claim 13, wherein the recommendation comprises at least one of an action for the user account to decrease spending on a transaction, increase spending on a transaction, or modify a budget for a specific period of time, or a combination thereof.

20. One or more non-transitory computer-readable media storing instructions that, when executed by a computing platform comprising at least one processor, and memory, cause the computing platform to:
receive account information associated with a user account, wherein the account information comprises historical account data and one or more user-defined account rules;
input, into a user ML model, the account information;
process, by the user ML model, the historical account data and the one or more user-defined account rules to determine a plurality of account features;
output, by the user ML model, the plurality of account features;
receive, from a media platform, unstructured media data;
input, into a media ML model, the unstructured media data;
process, by the media ML model, the unstructured media data to determine a plurality of media features;
output, by the media ML model, the plurality of media features;
input, into a recommendation ML model, the plurality of account features and the plurality of media features;
generate, by the recommendation ML model, tokens representing each of the plurality of media features and each of the plurality of account features, wherein the tokens are connected together in a fully connected graph structure;
delete, by the recommendation ML model, each of the tokens representing media features not matching with any of the tokens representing the plurality of account features;
process, by the recommendation ML model, a recommendation score based on the tokens in the fully connected graph structure representing the plurality of account features and the plurality of media features;
output, by the recommendation ML model, the recommendation score;
generate the recommendation for the user account based on the recommendation score; and
send, to a user computing device associated with the user account, the recommendation.
